(19) United States
(12) Patent Application Publication
(10) Pub. No.: US 2026/0332951 A1
(43) Pub. Date: Oct. 22, 2026

(54) WEARABLE AUDIO DEVICE WITH AN ADJUSTABLE AWARE MODE

(71) Applicant: Bose Corporation, Framingham, MA (US)

(72) Inventors: Emery M. Ku, Somerville, MA (US); Bin Li, Marlborough, MA (US); Leonard Varghese, Newtonville, MA (US)

(73) Assignee: Bose Corporation, Framingham, MA (US)

(21) Appl. No.: 19/185,154

(22) Filed: Apr. 21, 2025

(51) Int. Cl. H04R 3/04

(52) U.S. Cl. CPC H04R 3/04

(57) ABSTRACT

A wearable audio device with configurable aware mode, includes: an acoustic driver; an outer microphone outputting an outer microphone signal that represents ambient noise; and a control circuit configured to: filter the outer microphone signal with a filter to produce a aware signal; provide a drive signal to the acoustic driver such that the acoustic driver renders the acoustic signal according to the driver signal, wherein the drive signal is based, at least in part, on the aware signal; and adjust the frequency response of the filter.

### BACKGROUND

The present disclosure is generally directed to a wearable audio device with an adjustable aware mode.

### SUMMARY

The present disclosure is generally directed to a wearable audio device with an adjustable aware mode.

According to an aspect, a wearable audio device with configurable aware mode, includes: an acoustic driver; and a control circuit configured to: filter the outer microphone signal with a filter to produce an aware signal, wherein the outer microphone signal represents ambient noise; provide a drive signal to the acoustic driver such that the acoustic driver renders the acoustic signal according to the driver signal, wherein the drive signal is based, at least in part, on the aware signal; and adjust the frequency response of the filter according to an instruction received from a user interface.

In an example, the microphone signal is further filtered with a second filter to produce the aware signal.

In an example, the user interface is provided on an exterior of the wearable audio device.

In an example, the user interface is a button.

In an example, the user interface is a touch interface.

In an example, the outer microphone signal is the combined output of a plurality of outer microphones

In an example, the wearable audio device further includes an antenna, wherein the instruction is received via the antenna.

In an example, the user interface is a mobile application.

In an example, the user interface is a graphical equalizer.

In an example, the instruction is a command to implement a preset frequency response.

In an example, the filter includes a plurality of filters, wherein adjusting the frequency response of the filter comprises adjusting one or more gains of the plurality of filters.

In an example, adjusting the frequency response of the filter further includes adjusting one or more center frequencies of the plurality of filters.

According to another aspect, a method for configuring aware mode of a wearable audio device, includes: filtering an outer microphone signal with a filter to produce a aware signal, the outer microphone signal representing ambient noise; providing a drive signal to an acoustic driver such that the acoustic driver renders an acoustic signal according to the driver signal, wherein the drive signal is based, at least in part, on the aware signal; and adjusting the frequency response of the filter according to an instruction received from a user interface.

In an example, the microphone signal is further filtered with a second filter to produce the aware signal.

In an example, the user interface is provided on an exterior of the wearable audio device.

In an example, the user interface is a button.

In an example, the user interface is a touch interface.

In an example, the outer microphone signal is the combined output of a plurality of outer microphones.

In an example, the instruction is received via an antenna.

In an example, the user interface is a mobile application.

In an example, the user interface is a graphical equalizer.

In an example, the instruction is a command to implement a preset frequency response.

In an example, the filter includes a plurality of filters, wherein adjusting the frequency response of the filter comprises adjusting one or more gains of the plurality of filters.

In an example, adjusting the frequency response of the filter further includes adjusting one or more center frequencies of the plurality of filters.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a block diagram of a wearable audio device with an adjustable aware signal, in accordance with an example.

FIG. 2 is a graphic equalizer user interface, in accordance with an example.

FIG. 3 is a filter for adjusting an aware mode according to an instruction from a user interface, in accordance with an example.

FIG. 4 is a graphic equalizer user interface, in accordance with an example.

FIG. 5 is a plot depicting the magnitude of the original aware mode signal against the dynamically filtered signal across frequency.

FIG. 6 is a block diagram of a wearable audio device with an adjustable aware signal, in accordance with an example.

FIG. 7 is a flowchart of a method for adjusting an aware signal, in accordance with an example.

### DETAILED DESCRIPTION

Headphones, and particularly headphones with active noise reduction (ANR, also referred to as active noise cancellation or ANC), often provide a feature that permits a user to better hear ambient noise. In general, such features rely on microphones positioned to receive a signal representative of ambient noise. The signal from the microphones is transduced by a speaker to render the ambient noise to the user. Different headphone manufacturers refer this mode by different names, such as a “transparency,” “ambient,” “hearthrough,” “ambientaware,” or “aware mode.” For the purposes of this disclosure, this mode will be referred to as “aware mode.” Aware mode can be useful in situations where the user needs to hear the surrounding environment, such as crossing the road or engaging in a conversation.

Aware mode can thus provide the user with enhanced awareness of the user's surroundings, while still providing any desired audio content, and any desired active noise reduction. If ANR is active, certain undesirable noises, such as the low rumble of an airplane engine, will still be canceled. The result is that the user can hear the desired audio, along with controlled noise from the ambient environment.

While headphones might permit users to adjust the overall aware mode gain, there is currently no ability for a user to configure the relative strength of different frequencies in the aware mode signal. For example, certain users may prefer to decrease the gain of low frequency noises while increasing the gain of higher frequency noises: attenuating low-frequency noises that might be considered undesirable, while enhancing frequencies associated with voices. Other users may prefer to have a flat or constant-slope aware mode response, resulting in a natural sounding environment.

Additionally, headphones do not provide dynamic adjustment to the frequency response of the aware mode. For example, if the user is operating in aware mode while an infant is crying, there is currently no method to dynamically reduce frequencies associated with the crying baby while still delivering audio representative of the user's environment.

Turning now to the figures, there is generally disclosed a wearable audio device with an adjustable aware mode. The wearable audio device can include a control circuit, an acoustic driver, and an outside microphone. The outside microphone is positioned to capture ambient sounds (sounds within the environment) and generate an outside microphone signal that can form the basis of an aware signal.

The wearable audio device can also receive a playback audio signal. The playback audio signal may be provided by an external device in wired or wireless communication with the wearable audio device, such as a smartphone. The playback audio signal may include entertainment audio, telephone call audio, etc. In certain examples, the wearable audio device can provide an anti-noise signal to the user, configured to cancel certain undesirable ambient noise; though, in alternative examples, the wearable audio device can implement only a passive noise cancellation.

As will be described in detail below, in certain examples, the wearable audio device can implement a filter that filters the outside microphone signal to produce a filtered outside microphone signal. The frequency response of this filter can be configured with a user interface. In other examples, the frequency response of the filter can be adjusted dynamically, in response to the detected context of the environment to deliver a desired response.

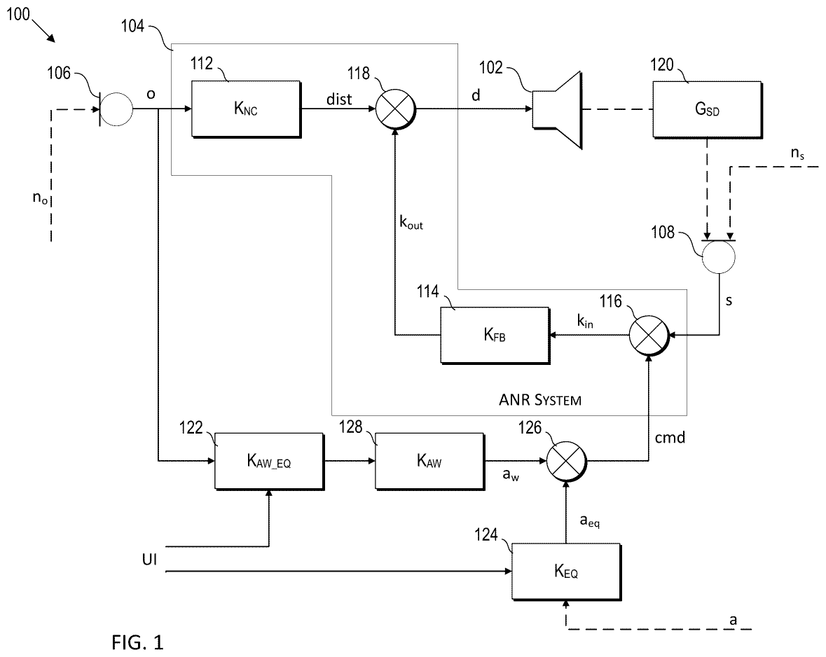

There is shown in FIG. 1, a block diagram of a wearable audio device 100 with a user-configurable aware mode. As will be described, the frequency response of a filter, filtering the outside microphone signal, is adjustable via a user interface. As shown, wearable audio device 100 includes an acoustic driver 102 that is positioned to provide an acoustic signal to the user (for example, acoustic driver 102 can be positioned within an earcup or an earbud nozzle). Acoustic driver 102 receives drive signal d and, in response, transduces an acoustic signal to the user. Drive signal d can include audio content (e.g., music, speech, aware mode) as well as an anti-noise signal generated by ANR system 104 configured to reduce ambient noise perceived by the user. In this example ANR system 104 generates the anti-noise signal according to microphone inputs from outer microphone 106 producing outer microphone signal o and system microphone 108 producing system microphone signal s.

Outer microphone 106 is positioned to provide an outer microphone signal representative of ambient noise. Thus, in an example, outer microphone 106 can be in acoustic communication with the exterior of wearable audio device 100 to detect ambient noise, as such noise is received at outer microphone 106. It will be understood that ambient noise is not constant across space, i.e., ambient noise varies in terms of physical location. Outer microphone 106 can be positioned to detect ambient noise as such noise is generally present at the user's ear, i.e., in a location useful for providing a signal that can be adapted for the aware mode of wearable audio device 100. And thus, the outer microphone signal being representative of ambient noise refers to such noise as is generally present at the user's ear, with sufficient fidelity for use with an aware mode.

In the example of FIG. 1, outer microphone signal o is provided to K_{aw_EQ} filter 122, the frequency response of which is adjustable according to an instruction received from a user interface UI. Additionally, or alternatively, the frequency response can be dynamically adjusted in response to the detected environment of the user. The details of this filter will be provided below, following a brief description of the operation of ANR system 104, and the remaining operation of FIG. 1.

System microphone 108 is positioned to detect the acoustic signal provided to the user, which can comprise the acoustic signal output from acoustic driver 102, well as residual noise nₛ, left uncancelled by the anti-noise signal provided as part of drive signal d. System microphone signal s thus receives the acoustic signal output from acoustic driver 102 according to transfer function G_{sd}, representing the path from acoustic driver 102 to system microphone 108. It will be understood that the physical path from acoustic driver 102 to system microphone 108 (represented by transfer function G_{sd}) is slightly different from the acoustic path to the user's ear drum. Likewise, the noise signal ns, as detected by system microphone 108, will vary slightly from the noise present at the user's ear drum. A person of ordinary skill in the art will understand that detecting the acoustic signal provided to the user refers to a detection that sufficiently approximates the signal heard by the user to be useful for providing a feedback signal to ANR system 104. Thus, the system microphone signal being representative of the acoustic signal provided to the user refers to a sufficient representation of such a signal to be useful for ANR.

Generally, it will be understood that system microphone 108 can be positioned within the acoustic volume that includes acoustic driver 102 and at least a portion of the user's ear canal. Such positions can include, for example, the interior of the ear cup of a pair of over-the-ear headphones or an interior surface of an earbud, such as the earbud nozzle.

System microphone signal s can thus be understood as a feedback signal provided to ANR system 104 and outer microphone signal o can be understood as a feedforward signal provided to ANR system 104. It should be understood that, although a single outer microphone 106 and a single system microphone 108 are shown, outer microphone 106 can comprise multiple outer microphones providing multiple outer microphone signals o and system microphone 108 can comprise multiple system microphone providing multiple system microphone signals s. To the extent that the ANR system 104 or K_{aw_EQ} filter 122 uses microphone signal o or microphone signal s, it will be understood by a person of ordinary skill in the art, that the methods implemented by these systems can be expanded to account for multiple outer microphone signals o and multiple system microphone signals s.

Additionally, to the extent that multiple outer microphones are used, the outer microphone signals o can be combined into a single outer microphone signal o that can be input K_{aw_EQ} filter 122. Beamforming techniques can further be used to focus (i.e., enhance) the outer microphone signal on ambient noise received from a particular direction (e.g., in front of a user), while reducing the ambient noise from other directions. It should thus be understood that outer microphone signal o can be the result of combining multiple outer microphone signals o and that outer microphone signal o, as input to K_{aw_EQ} filter 122, can be the result of additional processing of the outer microphone signal(s) o, such as beamforming. Methods of combining microphone signals and of beamforming are understood in the art and any suitable method can be used.

In the example of FIG. 1, ANR system 104 sums together two anti-noise signals—a feedforward anti-noise signal and a feedback anti-noise signal—to produce the anti-noise component of drive signal d. The first anti-noise signal is provided by filtering outer microphone signal o with feedforward filter K_{NC} 112 to produce disturbance injection signal dist, which is a feedforward anti-noise signal that reduces the ambient noise perceived by the user when transduced into the acoustic volume by acoustic driver 102. K_{NC} filter 112 is, in this example, a fixed feedforward ANC filter. Such filters are understood in the art and any suitable example of such filters can be used. In alternative examples, an adaptive or configurable fixed filter can be used.

The second anti-noise signal is provided by filtering the summed combination of system microphone signal s and command injection signal cmd at K_{FB} filter 114 to produce feedback output signal Kₒᵤₜ. System microphone signal s and command injection signal cmd are summed together at combiner 116 to produce feedback signal kᵢₙ, the input to K_{FB} filter 114. Command injection signal cmd includes audio content (e.g., music, speech, aware mode) that is desired by the user to be heard within the acoustic volume.

In this example, K_{FB} filter 114 is a fixed feedback ANC filter, and thus the output signal Kₒᵤₜ includes the content signal from command injection signal cmd and an anti-noise signal that likewise reduces the ambient noise perceived by the user when transduced into the acoustic volume by acoustic driver 102. Such filters are understood in the art and any suitable example of such filters can be used. In alternative examples, K_{NC} filter 112 can be adjusted either adaptively (as are known) or according to a user input designating a user preference of ANR setting.

The disturbance injection signal dist (i.e., the feedforward anti-noise signal) and the feedback output signal Kₒᵤₜ are summed at the combiner 118, the result being drive signal d provided to acoustic driver 102 (e.g., via any necessary amplification), which includes both the anti-noise signal resulting from both K_{NC} filter 112 and K_{FB} filter 114 and the audio content from command injection signal cmd.

As shown, the command injection signal cmd is comprised of two signals, an aware signal a_{w} and an audio content signal a_{eq}. The audio content signal a_{eq} is the result of filtering input audio content signal a through equalization filter KEQ. Audio content signal a is the content signal that includes music, speech, or any other desired audio input. Typically, audio content a is received from a connected mobile device, although other sources are contemplated.

K_{eq} filter 124 is an equalization filter implementing an equalization which is a default equalization or a user-defined equalization. Various types of equalization filters are understood in the art, and any suitable filter can be used. For example, equalization filter K_{eq} can be comprised of a collection of filters—together implementing an equalizer such as a graphical equalizer or a parametric equalizer—the frequency response of which can be determined by a user via a user interface UI. Various user interfaces for equalizers (e.g., a parametric equalizer interface, graphical equalizer interface) can be used.

As used herein, the “frequency response” of a filter refers to the way in which a filter affects the amplitude and phase of input signals at different frequencies. Thus, adjusting the frequency response refers to changing the way that the filter affects the amplitude and phase of input signals at different frequencies. An adjustment to the frequency response thus necessarily entails changing the amplitude of at least one frequency relative to another frequency. Thus, adjusting the overall gain of the filter, which adjusts the response across all frequencies equally, is not considered an adjustment of the “frequency response” of the filter.

As described above, aware signal a_{w} is the filtered result of outside microphone signal o. Specifically, outside microphone signal o is filtered by K_{aw_EQ} filter 122 and K_{aw} filter 128 to produce aware signal a_{w}. The frequency response of aware filter K_{aw_EQ} can be determined by an instruction received, in an example, from user interface UI. The user, thus, provides an instruction via the user interface to adjust the frequency response of K_{aw_EQ_EQ} filter 122. K_{aw} filter 128 is a default filter provided in the aware mode path to provide desired filtering for the aware signal a_{w}. While the frequency response of K_{aw_EQ} filter 122 is adjustable by the user, the frequency response of K_{aw} filter 128 is determined at manufacture and is not adjustable. In the example of FIG. 1, the K_{aw_EQ} filter 122 and K_{aw} filter 128 together provide the aware mode signal a_{w}. In alternative examples, K_{aw} filter 128 can be omitted.

The user interface, in an example, can be disposed on the exterior of wearable audio device 100. For example, the user interface can include a touch interface or one or more buttons located on the exterior of the wearable audio device. Alternatively, the instruction can be received via an antenna (e.g., included in a wireless module such as a Bluetooth module), disposed within wearable audio device 100, and providing a connection to a connected device, such as a mobile device or computer.

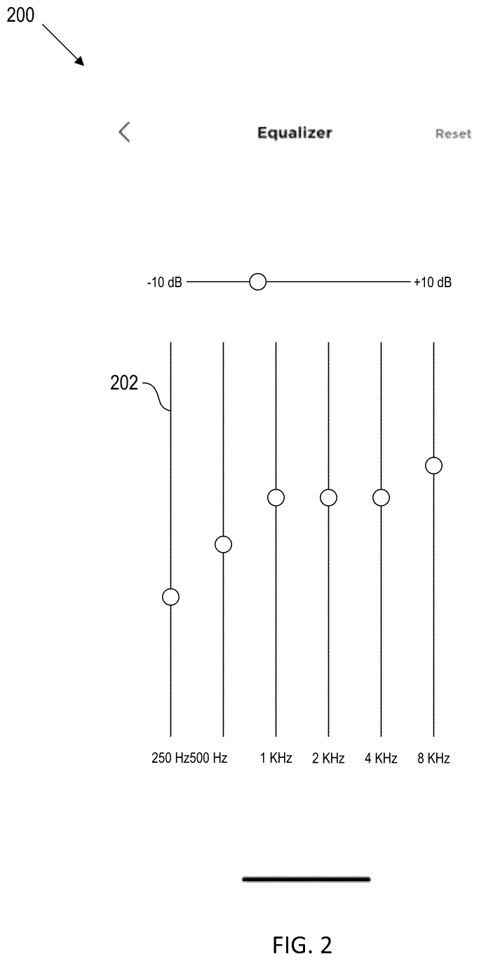

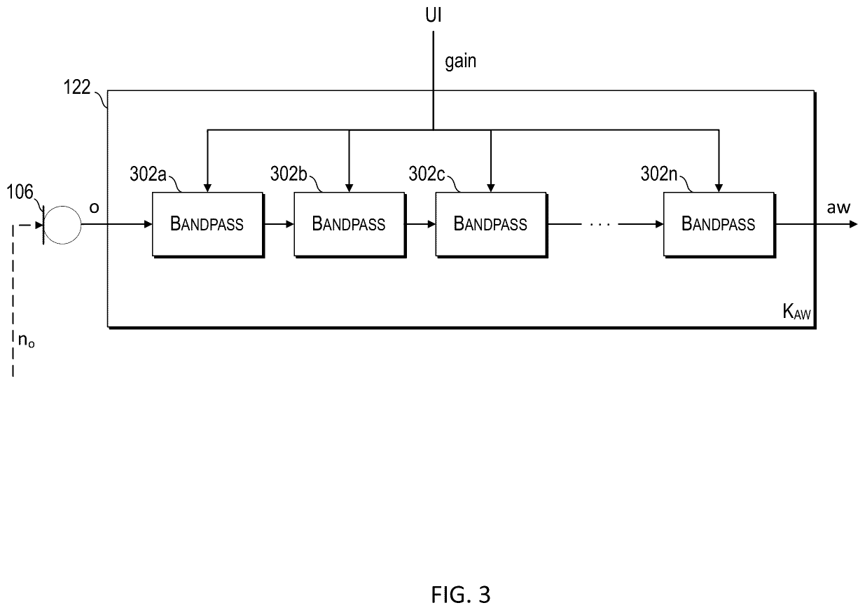

For example, K_{aw_EQ} filter 122 can be implemented as a graphical equalizer filter and thus can be controlled with user interface such as shown in FIG. 2, provided to a user, for example, via a dedicated mobile or computer application. As will be understood, the filter associated with a graphical equalizer is typically comprised of a collection of bandpass filters, each with a predefined center frequency that divides an input signal into a set of individually controllable frequency bands (though there can be some overlap between neighboring frequency bands). An example of a graphical equalizer filter topology is shown in FIG. 3, which depicts a cascaded set of bandpass filters 302a, 302b, 302c . . . 302n. Bandpass filters 302a-302n each filter a respective frequency band of the input outer microphone signal o, to provide the aware signal as the filtered output. The gain of each bandpass filter is set by the user interface, represented by the gain signal input to each bandpass filter 302a-302n. In an example, each bandpass filter can be implemented as a biquad filter, though any suitable filter type (including digital or analog filters) can be used. While bandpass filters 302a-302n are shown in a cascaded arrangement, it will be understood that, in alternative examples, the filters can be arranged in parallel.

To adjust the frequency response of K_{aw_EQ} filter 122, the user interface shown in FIG. 2, comprises a collection of sliders 202 (only the leftmost slider is marked with a reference numeral to avoid visual clutter), each slider controlling the gain of a particular bandpass filter 302a-302n and thus frequency band. In the example of FIG. 2, the sliders control bandpass filters with center frequencies of 250 Hz, 500 Hz, 1 KHz, 2 KHz, 4 KHz, and 8 KHz, though this is just an example of frequency bands that could be implemented in a graphical equalizer. Indeed, any number (greater than or equal to two) of bandpass filters 302a-302n can be used (as indicated by the “n” suffix).

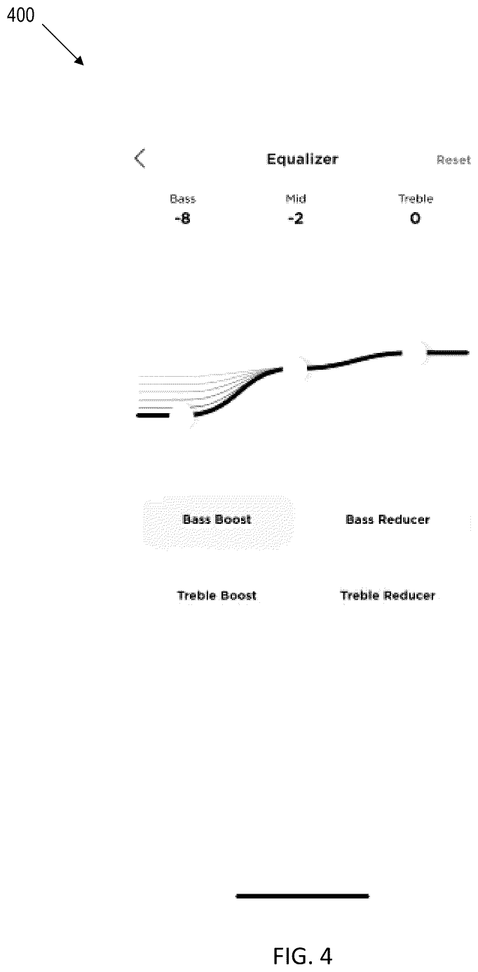

The user interface of FIG. 2 is only one example of a mobile application user interface to adjust the frequency response of K_{aw_EQ} filter 122, and, consequently, the equalization of aware signal a_{w}. FIG. 4 depicts another example of a graphical user interface, this one including control of the gain of three filters corresponding to bass frequencies, mid frequencies, and treble frequencies. While a user can adjust the gain of each frequency band by adjusting the bass, mid, and treble controls, the interface also includes a set of presets, corresponding to typical user settings. These presets are titled “bass boost,” “bass reducer,” “treble boost,” and “treble reducer,” with the “bass reducer” preset shown selected. As shown, “bass reducer” is a setting in which the bass frequency band is attenuated to −8 dB, the mid frequencies are attenuated to −2 dB, and the treble frequencies are left unchanged from the default setting. In an example, “treble reducer” preset is similar but reversed: treble is set to −6 dB, the mid frequencies to −2 dB, and the bass frequencies are left unchanged. For the sake of completeness, in an example, the “bass boost” setting sets the bass to +8 dB and leaves the other settings unchanged from the default, and the “treble boost” setting sets the treble to +6 dB and leaves the other settings unchanged from the default. These settings are simply examples of presets that could be included.

It will be understood that, in another example, the presets can be tailored to different contexts such as “conversation” to emphasize frequencies associated with the human voice, or “traffic aware” to emphasize frequencies associated with engines or road noise to ensure the sounds of approaching cars are audible.

Such presets can, alternatively, be selected through an exterior user interface, such as a button or touch interface. Thus, the instruction provided by the user through such an interface can implement a stored preset setting, such as “treble reducer,” “conversation” or “traffic aware.”

Furthermore, although the above example includes various gain settings for fixed bandpass filters, a more granular control is conceivable. For example, rather than a graphical equalizer, a parametric equalizer can used. Parametric equalizers, as will be understood by a person of ordinary skill in the art, typically provide control of the type of filters implemented (high pass, low pass, bandpass, shelf), the center frequency of each filter, the bandwidth of each filter, and the Q factor of each filter. The filters according to these parameters are often cascaded, like the cascaded filters shown in FIG. 3, or can be arranged in parallel. User interfaces for parametric equalizers are understood in the art, and any suitable such interface could be implemented on a mobile device or a computer (e.g., with an application) to provide control of K_{aw_EQ} filter 122, here implemented as a parametric equalizer filter.

In the above examples, the user instruction is received as a command signal from the user interface, e.g., from a wireless signal originating at a mobile device or a signal from an interface on the exterior of wearable audio device 100. In these examples, the command signal can assume any number of forms and encode the instruction in any number of ways. In the mobile application interface example, the instruction can be encoded in the wireless signal, e.g., in accordance with the Bluetooth standard. Even within this example, the encoding can take a variety of forms, from a value corresponding to a preset that can be retrieved from memory, to a set of values representing the parameters of the filters of K_{aw_EQ} filter 122. Alternatively, the instruction, if received from the button, the instruction can be a “high” value or “low” value indicating a button press. The number of button presses or the length of the button press can indicate which preset the user is accessing. For example, a single button press can be “conversation”; whereas two button presses can be “traffic” and so on. Alternatively, various predetermined gestures (e.g., one finger swipe, two finger swipe) made onto a touch interface can be mapped onto various presets stored in memory. The filter parameters of the preset can then be retrieved from memory (e.g., the memory of the control circuit, described in more detail below).

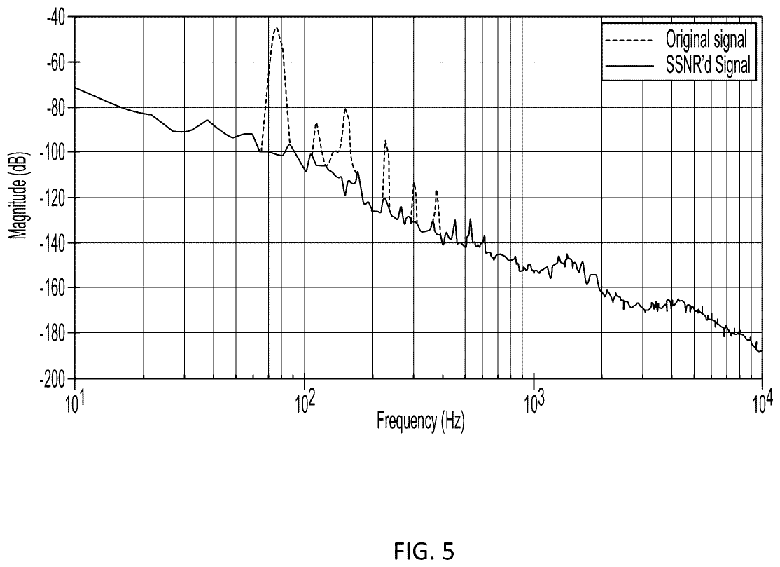

Alternatively, or additionally, the frequency response of filter K_{aw_EQ} filter 122 can be adjusted dynamically to adapt to environmental conditions. For example, in transportation environments, a user may want to reduce low frequency engine noises and rumble sounds while maintaining awareness at higher frequencies. Another example of this could be in the “crying baby” scenario. An adult may want to maintain awareness of the surroundings while an infant is crying, but in this situation only the louder higher frequencies are automatically attenuated to maintain the overall flat or constant-slope spectral response of the outside world. Such an example of dynamically adjusting the frequency response of K_{aw_EQ} filter 122 is shown in FIG. 5. More specifically, FIG. 5 is plot depicting the magnitude of the original aware mode signal against the dynamically filtered signal across frequency. As shown, the peaks of the original signal are smoothed across frequency to dynamically reduce the noisiness of the aware mode signal, while still providing the user with the desired awareness. Examples of dynamic filters are understood in the art and any suitable example can be used. For example, an adaptive FIR filter can be used, the adaptive FIR filter being adapted using methods such as least mean squares and recursive lease squares. Alternatively, an adaptive IIR filter can be adapted based on the outer microphone signal o, system microphone signal s, and drive signal d. These examples adjust the K_{aw_EQ} filter 122 parameters (i.e., the frequency response of the filter) in real-time to according to the environment, can thus be used to adapt the aware mode signal to the environment in a desirable manner.

In the example of FIG. 1, the content of command injection signal c_{md} (e.g., music, speech, aware mode) is provided to acoustic driver via the feedback anti-noise filter, i.e., K_{FB} filter 114. It should be understood that, in other examples, this audio content can be provided to acoustic driver 102 via other paths, including directly or through the feedforward anti-noise filter such as K_{NC} filter 112. Further, it should be understood that the aware signal a_{w} can be provided to the acoustic driver 102 via additional signal processing (e.g., filters, combiners, etc.).

Additionally, while ANR system 104 described above includes both a feedback and feedforward ANR topology, it should be understood that, in alternative examples, a feedback-only or a feedforward-only topology can be used. Such topologies are understood in the art, and any suitable ANR system can be used. Indeed, the user-adjustable aware mode filter described herein can be used without an ANR system. For example, certain wearable audio devices can employ passive, rather than active, noise cancellation—i.e., creating a physical barrier between the user and the surrounding environment to reduce the user's perception of ambient noise. In such situations, an aware mode can be used to provide the user with a desired perception of the environment, while still passively isolating the user from undesirable frequencies. A user-adjustable and/or dynamic aware filter, such as K_{aw_EQ} filter 122, can be used in such passive noise cancellation designs to provide the user with the ability to adjust the kind of ambient noise delivered to the user via the aware mode system.

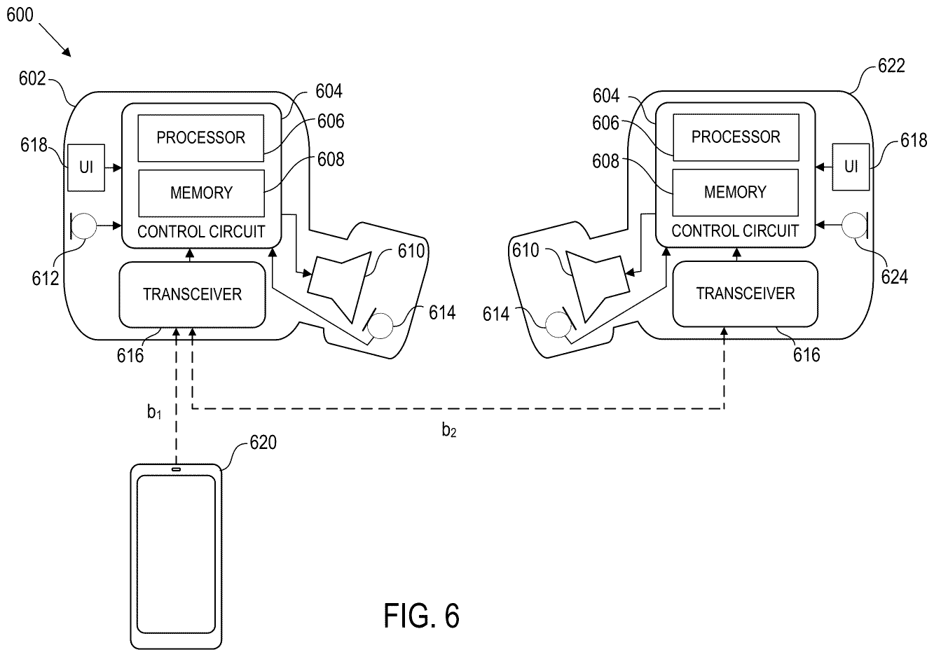

FIG. 6 depicts simplified block diagram of an example wearable audio device 600. In this example, the wearable audio device is a pair of earbuds, though, for the purposes of this disclosure, the term “wearable audio device” is used as an umbrella term for any personal audio wearable worn on a user's head. As such, the term can encompass form factors such as over-ear headphones, on-ear headphones, ear buds, in-ear monitors, closed or open headphones, hearing aids, aviation headsets etc. As shown in FIG. 6, left earbud 602 includes control circuit 604, which can includes processor 606 and memory 608 Memory can be non-transitory storage medium storing program code to be executed by processor 606 for implementing the various processes and methods described in this disclosure, including the user adjustable and/or dynamically adjustable user aware mode, as well as any additional functions such as ANR. In an example, control circuit 604 can implement the topology described in conjunction with FIG. 1. Thus, as shown, wearable audio device further includes transducer 610, outside microphone 612 (positioned to detect ambient noise), and system microphone 614 (positioned to detect the acoustic signal delivered to the user). Left earbud 602 further includes a user interface U1 618 (e.g., one or more buttons, a touch interface, etc.) for a user to input various instructions. These instructions can include on/off, adjusting ANR settings, or, as described above, adjusting the frequency response of a filter filtering the outer microphone 612 signal to adjust the user's perception of the aware mode according to multiple possible presets.

In this example, a transceiver is also included (e.g., a Bluetooth module) for communicating with mobile device 620 (via wireless connection b1) and for communicating with right earbud 622 (via wireless connection b2). (Alternatively, a wired connection can be used.) In this example, a second user interface can be provided on mobile device 620, which can include a dedicated application that includes an interface such as a graphic equalizer (as shown, for example, in FIGS. 2 and 4) or a parametric equalizer, although other suitable user interfaces for adjusting the frequency response of the outside microphone 612 filter can be used. Mobile device 620 thus delivers instructions from the user interface to the wearable audio device 600. In this example, the instructions are sent to left earbud 602, which forwards the instructions to right earbud 622. In alternative example, mobile device 620 can deliver instructions to be left earbud 602 and right earbud 622 individually.

In this example, right earbud 622 includes the same components as left earbud 602 and likewise implements the adjustments of the frequency response of a filter filtering the signal received from outside microphone 624 (the signal from which is indicative of ambient noise at right earbud 622), in response to the instruction received from mobile device 620 user interface or the user interface 618. While two different control circuits are shown in FIG. 6, it should be understood that a single control circuit can be used in certain form factors (such as over-the-ear headphones, or wired earbuds).

The control circuit 604 described in FIG. 6, the processing described in this disclosure (including filtering the outside microphone signal, adjusting the frequency response of the filter, providing active noise reduction, etc.) and the methods described below can be implemented by any suitable circuitry. Such circuitry can include one or more processors, such as digital signal processors (DSPs), microcontrollers, microprocessors, systems-on-chip (SoCs), field-programmable gate arrays (FPGAs), etc, together with one or more non-transitory storage media (such as non-volatile storage) that can store program code to be executed on the one or more processors. (Certain examples, such as microcontrollers and SoCs, include both processor(s) and at least one non-transitory storage medium in a single self-contained package.) Alternatively, or additionally, non-processor-based hardware, such application-specific integrated circuits (ASICs) can be used. Together, the circuitry for implementing the methods described in this disclosure can be referred to as a control circuit. The control circuit can thus be a single discrete component (such as a DSP), or can be a combination of components (e.g., one or more microcontrollers or ASICs) working in concert to accomplish the processing and methods described in this disclosure. The types of individual components described herein, including digital filters (e.g., bandpass filters, filters used in equalizers, active noise cancellation filters, beamforming, etc.) are generally understood in the art, and any suitable circuit(s) for implementing these components can be used.

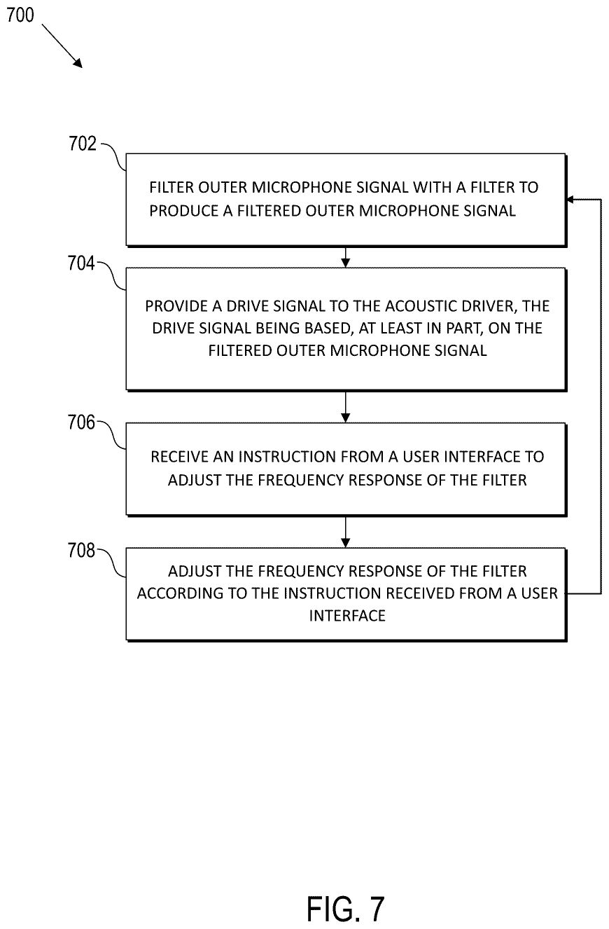

Turning now to FIG. 7 there is shown a method 700 for providing user control of the frequency response of an aware mode filter of wearable audio device. The steps of method 700 can be accomplished by a control circuit, which, as described above, can include one or more processors, application-specific integrated circuits, and/or associated hardware to accomplish the steps. Accordingly, the steps of method 700 can, in certain examples, be stored in one or more non-transitory storage medium (such as non-volatile storage) and executed with one or more processors.

The steps of the method 700 uses at least one outside microphone that outputs an outer microphone signal representing ambient noise. The steps of method 700 further use at least one acoustic driver that is positioned to deliver an acoustic signal to a user. As such, the acoustic driver can be located within, e.g., an ear cup or a nozzle of an earbud. In various examples, the control circuit wearable audio device can include an ANR system provide an anti-noise signal to the acoustic driver to reduce the user's perception of ambient noise. The ANR system can use the outside microphone, a system microphone, or both, to generate the anti-noise signal. However, it should be understood that passive noise cancellation can be used alternatively or in addition to ANR.

At step 702, an outer microphone signal is filtered with a filter to produce a aware signal. It should be understood that the filter can comprise a set of filters, together filtering the signal to provide the aware signal. For example, the filter can be a set of bandpass filters of a graphical equalizer, each respectively filtering a predetermined frequency band of the aware signal. Alternatively, the filter can comprise a set of filters of a parametric equalizer, filtering according to the filter type (e.g., high pass, low pass, bandpass, or shelf) and bandwidth or corner frequency of filter. The use of filters, and equalizers, for the filtering of audio is generally understood in the art. Any suitable filter (which itself can comprise a set of filters) can be used to filter the outer microphone signal.

Further, it should be understood that the outer microphone signal can itself be the combined result of multiple outer microphones. Further, additional processing, such as beamforming, can be used to enhance the ambient noise detected in a certain direction, while reducing the noise in other directions. Accordingly, the outer microphone signal that is input to the filter can be the combined result of multiple outer microphone signals and can be the result one or more additional processes, such as beamforming.

At step 704, a drive signal is provided to the acoustic driver such that the acoustic driver renders an acoustic signal according to the driver signal. The drive signal is based, at least in part, on the aware signal. In an example, drive signal can comprise only the aware signal; i.e., the aware signal is provided to an acoustic driver to be rendered into an acoustic signal and delivered to the user without intervening signal processing (excluding operations such as amplification necessary to condition the drive signal for rendering by the acoustic driver). However, in alternative examples, the aware signal can be provided via additional signal processing, such as via one or more anti-noise filters or being combined with one or more signals such as other desired audio content (e.g., music, speech). As described above, the aware signal can be provided to the acoustic driver in conjunction with ANR system providing an anti-noise signal.

At step 706, an instruction from the user is received from a user interface to adjust the frequency response of the outer microphone filter. The user interface can take any suitable form. In an example, the user interface is disposed on the exterior of the wearable audio device, e.g., as one or more buttons or a touch interface. Alternatively, the user interface can be provided on the screen of a connection mobile device or computer (e.g., depicted as a graphical or parametric equalizer). The connection to the mobile device or computer can be wired or wireless (e.g., a Bluetooth connection, though other wireless protocols are conceivable). The instruction, depending on the user interface, can take a number of forms, such as a value or set of values encoded in the wired/wireless communication, or as a “high” or “low” value according with a button press.

At step 708, the frequency response of the filter is adjusted according to an instruction received from a user interface. This step can comprise interpreting the received signal and adjusting the frequency response of the filter accordingly. For example, this step can comprise interpreting an encoded Bluetooth signal to render a set of parameters of the filter (e.g., gains, center frequencies, bandwidth, filter type, or any other characteristic that impacts the frequency response of the filter), and adjusting the filter to match the parameters received. This step can also comprise retrieving from memory a preset frequency response (i.e., a set of stored filter parameters) that are retrieved in response to the user selecting a preset (e.g., conversation, traffic, treble reducer). The preset can be selected, for example, on a dedicated app in a computer or mobile device, or with one or more button presses or a preconfigured gesture input to a touch interface. Regardless of whether the filter parameters are received from the connection to another device or retrieved from memory, the parameters can be implemented into the filter such that the outer microphone signal will be filtered according to the frequency selected by the user.

Next, the method returns to step 702 to filter the outer microphone signal according to the adjusted frequency response of the filter.

Accordingly, the above described systems and methods, an adjustable (user configurable or dynamic) aware mode can be provided to a user.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. As noted above, when any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

What is claimed is:

1. A wearable audio device with configurable aware mode, comprising:
an acoustic driver; and
a control circuit configured to:
filter an outer microphone signal with a filter to produce an aware signal, wherein the outer microphone signal represents ambient noise;
provide a drive signal to the acoustic driver such that the acoustic driver renders the acoustic signal according to the driver signal, wherein the drive signal is based, at least in part, on the aware signal; and
adjust the frequency response of the filter according to an instruction received from a user interface.

2. The wearable audio device of claim 1, wherein the user interface is provided on an exterior of the wearable audio device.

3. The wearable audio device of claim 2, wherein the user interface is a button.

4. The wearable audio device of claim 2, wherein the outer microphone signal is the combined output of a plurality of outer microphones.

5. The wearable audio device of claim 1, further comprising an antenna, wherein the instruction is received via the antenna.

6. The wearable audio device of claim 5, wherein the user interface is a mobile application.

7. The wearable audio device of claim 6, wherein the user interface is a graphical equalizer.

8. The wearable audio device of claim 1, wherein the instruction is a command to implement a preset frequency response.

9. The wearable audio device of claim 1, wherein the filter comprises a plurality of filters, wherein adjusting the frequency response of the filter comprises adjusting one or more gains of the plurality of filters.

10. The wearable audio device of claim 9, wherein adjusting the frequency response of the filter further comprises adjusting one or more center frequencies of the plurality of filters.

11. A method for configuring aware mode of a wearable audio device, comprising:
filtering an outer microphone signal with a filter to produce a aware signal, the outer microphone signal representing ambient noise;
providing a drive signal to an acoustic driver such that the acoustic driver renders an acoustic signal according to the driver signal, wherein the drive signal is based, at least in part, on the aware signal; and
adjusting the frequency response of the filter according to an instruction received from a user interface.

12. The method of claim 11, wherein the user interface is provided on an exterior of the wearable audio device.

13. The method of claim 12, wherein the user interface is a button.

14. The method of claim 12, wherein the outer microphone signal is the combined output of a plurality of outer microphones.

15. The method of claim 11, wherein the instruction is received via an antenna.

16. The method of claim 15, wherein the user interface is a mobile application.

17. The method of claim 16, wherein the user interface is a graphical equalizer.

18. The method of claim 11, wherein the instruction is a command to implement a preset frequency response.

19. The method of claim 11, wherein the filter comprises a plurality of filters, wherein adjusting the frequency response of the filter comprises adjusting one or more gains of the plurality of filters.

20. The method of claim 19, wherein adjusting the frequency response of the filter further comprises adjusting one or more center frequencies of the plurality of filters.
